(19) United States
(12) Patent Application Publication
(10) Pub. No.: US 2011/0121104 A1
(43) Pub. Date: May 26, 2011

(54) Lawn Irrigation System

(76) Inventor: Richard W. Battaglia, Concord, NH (US)

(21) Appl. No.: 12/622,773

(22) Filed: Nov. 20, 2009

(51) Int. Cl. B05B 1/14

(52) U.S. Cl. 239/436

(57) ABSTRACT

A nozzle for distributing the flow of a liquid comprises two connected modules. The first module engages with a liquid source, defines a liquid flow path forming a channel, has a first chamber and a portion of a second chamber, and at least one discharge orifice. The second module has a portion of the second chamber, a discharge orifice, and an cap. The nozzle may be used for liquid application to areas, particularly for lawn irrigation with water.

### FIELD OF THE INVENTION

This invention relates to an irrigation spray nozzle and, more specifically, to an adjustable spray nozzle head allowing for two or more discharge orifices, with the discharge orifices being located in different horizontal planes.

### BACKGROUND

There are various types of irrigation nozzles on the market. Some of these nozzles are used on a fixed water supply riser, and are attached to permanently provide a spray coverage area. Other nozzles are attached to “pop-up” supply risers, which activate upon application of water pressure to lift the nozzle above a horizontal plane for lawn irrigation. These and other existing spray nozzles typically include one discharge orifice to distribute water in a pre-set stream or spray pattern of predetermined area coverage.

For example, existing spray nozzles discharge water in a circular pattern. It is known to limit the spray to only certain segments of the circular pattern; for example, a circular nozzle spray pattern can be set so that only half of a circle is sprayed with water, or one-quarter, or the like.

Nozzles also exist that can achieve rectangular spray patterns. In these nozzles, the nozzle is placed geometrically within the rectangular pattern to be used to create different rectangularly watered surfaces. There are three basic types of rectangular pattern nozzles: side strip (SST), end strip (EST), and center strip (CST). A SST nozzle is located at the edge of the rectangular water pattern, at the middle of the long side of the rectangle. Thus, if a 30 foot by 4 foot (30′×4′) pattern is desired, a SST nozzle would be located at the middle of one of the 30′ sides. In this example, the nozzle will discharge water 15 feet to the left, 15 feet to the right, and 4 feet in front to form the desired rectangular pattern. The SST nozzle allows water to be discharged on three quadrants to create a rectangle, thereby allowing patterns to be formed where one quadrant does not receive water protection (for example, to prevent overspray on sidewalks, driveways, or the like). An end strip (EST) nozzle is used to form smaller rectangular segments and to control discharge on three quadrants of a rectangular water pattern. The EST nozzle is placed at the middle of the short side of the rectangle. For example, a 4 foot by 30 foot EST nozzle would be located at the middle of one of the 4 foot sides. This nozzle would discharge water two feet to the left of the nozzle, two feet to the right of the sprinkler (thus forming the short side of the spray pattern), and 30 feet in front to form the 4 foot by 30 foot rectangular spray pattern. Finally, a center strip (CST) nozzle can be used to discharge water uniformly, in all affected quadrants, to create a rectangular pattern. The CST nozzle is located in the center of the rectangle. For a 4 foot by 30 foot spray pattern, the CST nozzle will discharge water 15 feet to the left, 15 feet to the right, 2 feet in front, and 2 feet behind to form the 4 foot by 30 foot rectangular spray pattern.

One shortcoming of many existing spray nozzles is the inability to offer variable spray configurations for rectangular spray patterns. Adjustable spray patterns exist for circular nozzles, allowing different configurations to be set in circular patterns. For example, U.S. Pat. No. 6,158,675 discloses a nozzle that accommodates variable water pressures, with the result being the ability to throw the water different distances in the spray pattern, thus creating a variable, albeit circular, pattern. However, the discharge orifices in this invention are fixed, not variable, and generally relate to circular spray paths.

Other exemplary nozzles achieve a variable circular pattern by different designs and methods. U.S. Pat. No. 5,322,223 discloses a “helical slot” in the same general horizontal plane which allows for blocking and unblocking portions of the discharge orifice to preselect an angle to be used for the water pattern. The spray pattern is circular; the amount of coverage varies by opening various portions of the helical slot. U.S. Pat. No. 5,050,800 discloses a circular spray nozzle that allows an adjustment to the specific arcs within the circular pattern desired to affect spray coverage. U.S. Pat. No. 4,739,934 discloses another invention for obtaining variable coverage for circular, as opposed to rectangular, spray patterns.

These prior art spray nozzles do not allow variable rectangular spray patterns. To obtain rectangular spray patterns, previous systems have used multiple circular spray devices to create “wedge areas” that allow an area to be irrigated. These systems use either one, or multiple, spray heads. However, much overspray results from these systems, as they project circular patterns (or portions thereof) in multiple configurations to obtain rectangular coverage. Other prior art rectangular spray patterns require that the water be discharged in a preset pattern (such as a “left” rectangle or “right” rectangle), as shown U.S. Pat.No. 7,303,153.

### SUMMARY OF THE INVENTION

An object of the present invention is to present a nozzle that can obtain a variable rectangular spray pattern. This nozzle is adjustable and allows for more accurate watering of specific areas of the surface to be irrigated. In particular, the nozzle of the present invention is configured such that it can be adjusted to compensate for turns in a sidewalk, roadway, parkway, or other area defining the irrigation area. This in turn allows the desired area to be irrigated with more precision, with minimal or no overspray on the area not desired to be irrigated. The better spray patterns achieved with the nozzle of the present invention allow other benefits, such as minimizing the amount of water flowing from the non-irrigated area into a sewer system, or the amount of water collecting in undesired areas. Thus, the nozzle of the present invention allows for irrigation patterns to be obtained that follow curved boundaries (such as watering gross along a curved sidewalk), thus allowing for the irrigation curved surfaces or planting areas.

The present invention is a spray nozzle for distributing the flow of a liquid, such as water, having a base module creating at least one flow path, a first chamber, and a second chamber, and at least one discharge orifice; an upper module creating at least one flow path, a second chamber, and at least one discharge orifice; and an attachment device connecting the base module and the upper module, such that said base module and said upper module can be rotated about a common axis. In this manner water may flow from a pressurized water source connected to the base module through a flow path, into the lower and upper chambers, and out the orifices contained in the upper and lower chambers. An angularly variable spray pattern may then be developed with reference to the two discharge orifices to allow for variable spray patterns.

### BRIEF DESCRIPTION OF THE DRAWINGS

FIG. 1 shows a comparison of a prior art center strip (CST) nozzle and the present invention;

FIG. 2 shows use of a nozzle of the present invention in a 15 foot CST configuration;

FIG. 3 shows the nozzle of the present invention; and

FIG. 4 shows another view of the nozzle of the present invention.

### DETAILED DESCRIPTION OF THE INVENTION

In the present invention, the nozzle, or spray head, comprises two separate water chambers. The lower chamber collects the water and distributes the water through two internal flow paths to the upper chamber. The upper chamber has two orifices that allow for water discharge. Water flows from the lower chamber, to the upper chamber, and out of each orifice. This in turn delivers water in a specific pattern to the turf or plants.

The nozzle has a base module and an upper module, configured so that they can be moved relative to each other. The base module contains the lower chamber, a portion of the upper chamber, and one orifice. The upper module contains a portion of the upper chamber and a second orifice. The two modules are fastened in such a manner that they can be rotated around a common axis relative to each other. For example, if the lower module remains fixed, the upper module can rotate relative to the lower module, about an axis defined by an attachment device. The two modules can also be sealed with an appropriate sealing device to prevent water leakage while the modules are being rotated.

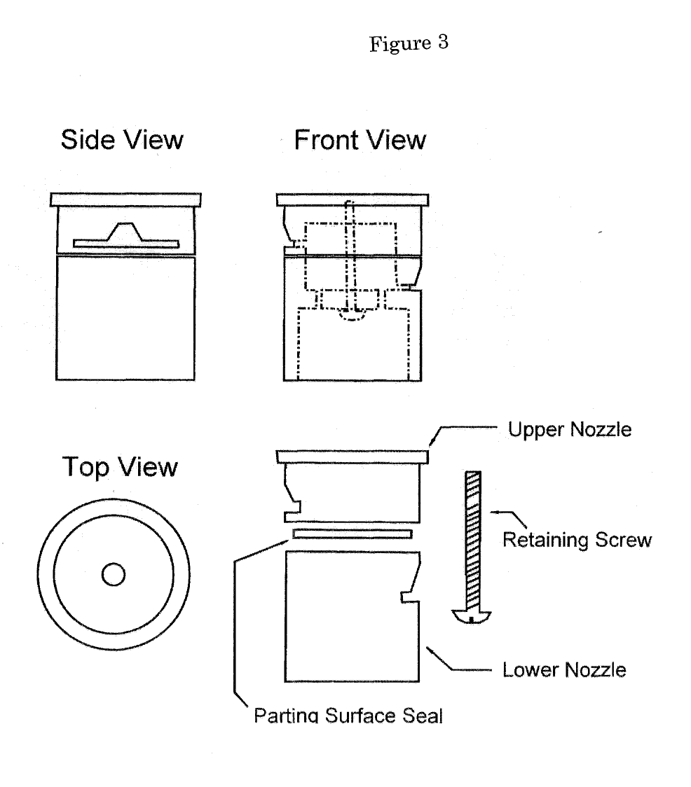

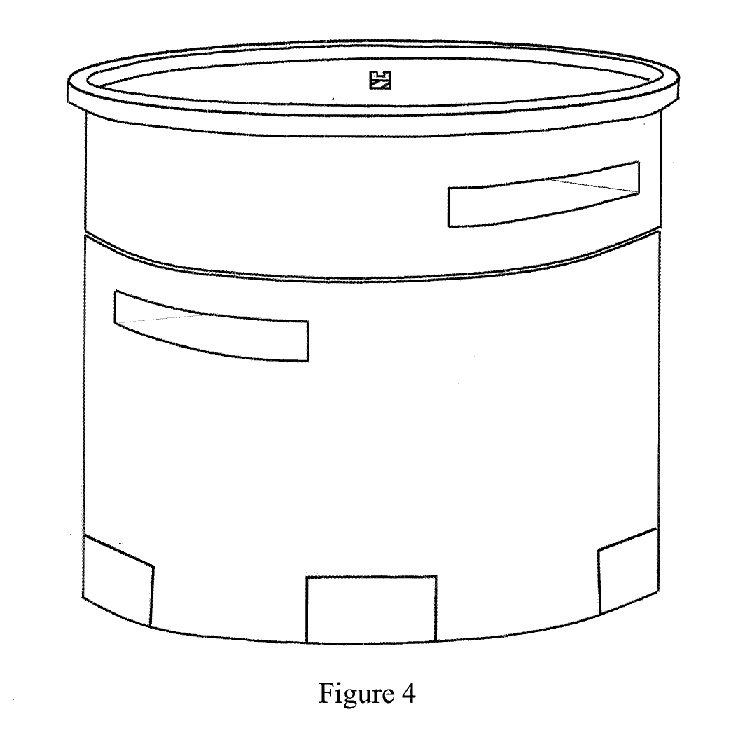

FIGS. 3 and 4 of the drawings illustrate an adjustable nozzle 1 according to a preferred embodiment of the present invention, which is designed to be mounted on a suitable liquid supply tube or riser. The nozzle 1 is connected to the liquid supply tube or riser in a manner such that liquid passes from the supply tube or riser to the nozzle through an orifice located in the bottom of the nozzle. The nozzle 1 can be of any configuration; the preferred embodiment is a cylindrical member having a base module 2 and upper module 4. The upper module has a cap on top which forms an enclosed area such that the liquid discharges through the orifices.

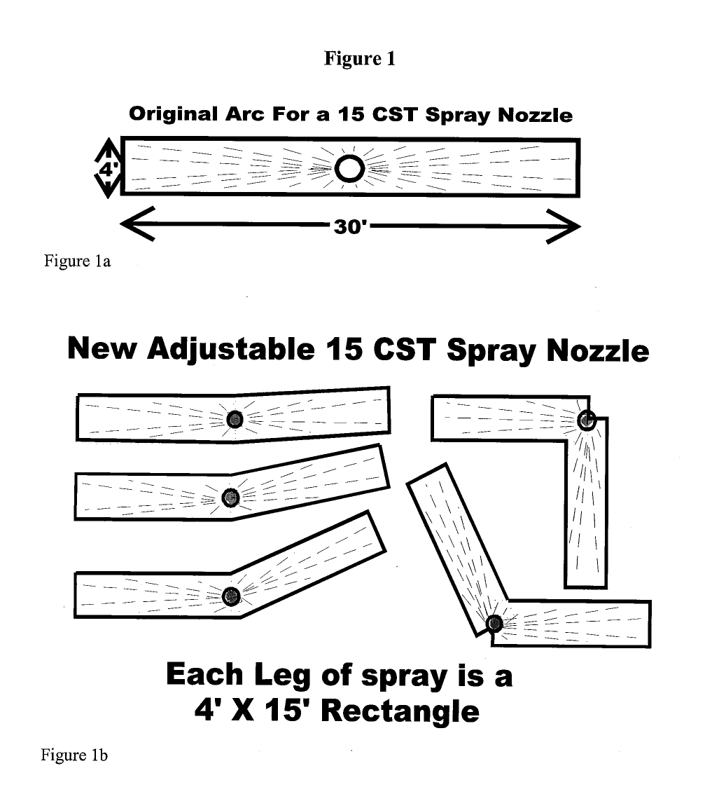

Nozzle 1 allows different rectangular spray configurations than the nozzles of the prior art. For example, in the prior art CST nozzle (FIG. 1a), the nozzle is configured to discharge water to the two long sides, and the two short sides. However, the pattern is “set” or fixed in that only (in the example) a four foot by thirty foot rectangular pattern can be achieved. In the present invention, one-half of the rectangular pattern can be adjusted to create an angularly displaced discharge pattern (FIG. 1b). The adjustable nozzle of the present invention has two discharge orifices that are angularly displaced from each other up to 360 degrees. Thus, one orifice can be set to discharge water to the left side of the nozzle by setting it to discharge water from 180 degrees to 360 degrees (in the rectangular pattern). The prior art nozzles will discharge water from 0 degrees to 180 degrees—to the right side of the nozzle—in the rectangular patterns. The present invention allows an angular offset, so that the coverage can vary. Thus, the nozzle can be configured to discharge water to the left in the normal pattern (from 180 degrees to 360 degrees), while discharge to the right can be offset by 30 degrees, thereby allowing a spray pattern to cover from 30 degrees to 210 degrees. Any angular displacement can be configured to obtain a variable 4 foot by 30 foot pattern, comprised of two 4 foot by 15 foot segments.

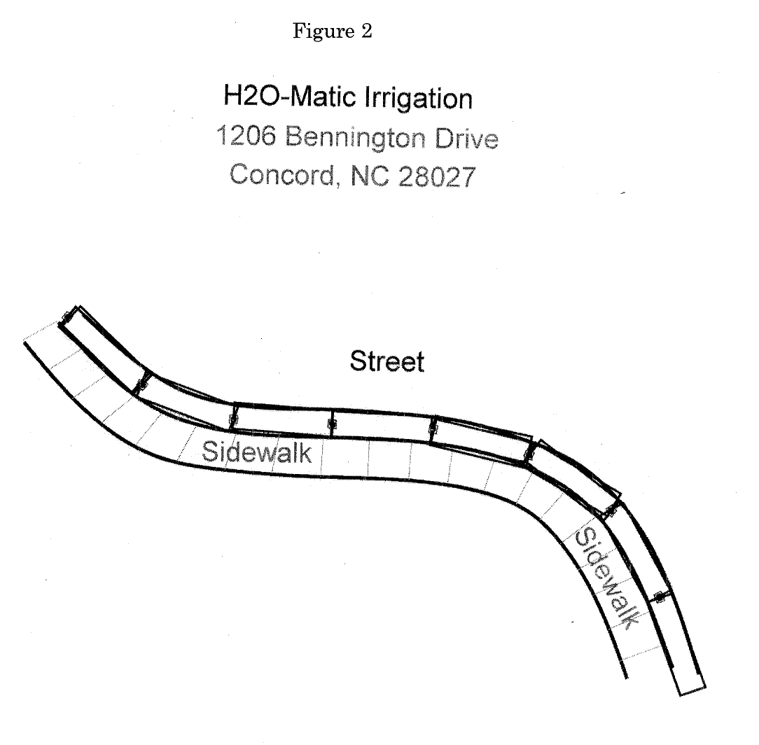

Use of the nozzle of the present invention is shown in FIG. 2. In prior art nozzles, irrigation of an irregularly shaped area, requires non-variable rectangular applications, such that overspray occurs. Use of the nozzles of the present invention allow the rectangular patterns to be varied, so that the use of nozzles will allow variable half-rectangular patterns to more closely follow a curved irrigation area. FIG. 2, for example, shows the use of the present invention in an area bordering a curved sidewalk.

The specific nozzle of the present invention is shown in FIG. 3. The nozzle has two distinct water chambers, and upper chamber 1 and a lower chamber 3, connected by an internal flow path 5. FIG. 3 shows two flow paths connecting the upper and lower chambers; any number of flow paths may exist in the present invention. The chambers are contained in the base module 2 and upper module 4. The base module 2 contains the lower water chamber 3, the flow paths 5, and a portion of the upper water chamber 1.

The nozzle connects to a pressurized water source at base module 2. Base module 2 contains at least one discharge orifice 7. The upper module 4 contains a portion of the upper water chamber 1, and at least one discharge orifice 6. The upper and base modules 4 and 2 are attached by an attachment device 10. A regular screw is used in the preferred embodiment of the attachment device, although any device that allows the modules to rotate may be used. The base and upper modules 2 and 4 are configured and attached by attachment device 10 so that they may rotate about the axis defined by the attachment device. The upper chamber 1 is also configured in both the base and upper modules 2 and 4 so that any rotation maintains the configuration of the upper chamber. A sealing device, such as a common rubber washer or o-ring, may also be placed between the upper and lower modules so that no fluid leakage occurs.

Because the upper and base modules 4 and 2 can rotate relative to each other, the discharge orifices 6 and 7 may be offset at different angles. The discharge orifice 7 in the base module 2 can, for example, be at a 0 degree position, while the discharge orifice 6 in the upper module 4 can be set at the 190 degree position. In this example water would enter the lower chamber 3, flow through the internal flow path 5 to the upper chamber 1, flow out the discharge orifice 7 in the base module 2 (set at 0 degrees), and flow out the discharge orifice 6 in the upper module 4 (set at 190 degrees relative to the lower module). In this manner the nozzle of the present invention presents an adjustable nozzle that allows varying spray configurations.

The distance at which the water may be sprayed by the current invention may be varied by techniques known in the art. For example, the discharge orifices may be “raked”, or have the outlet angle changed, to control the angle of water trajectory from the orifice. Moreover, the amount of water distributed to the sides can be varied by the design of the discharge orifices to achieve a desired pattern, such as a quarter-circle, half-circle, square, or other pattern.

As will be understood by those skilled in the art, changes in the device described above may be made by the skilled practitioner without departing from the spirit and scope of the invention. For example, while the preferred embodiment is for water irrigation, any suitable liquid of may be discharged through the nozzle of the present invention. In addition, the attachment device between base and upper modules can be any suitable device or means to connect the two modules while allowing rotation about a common axis. As yet another example, the shape of the device may be of any suitable design other than a cylindrical shape.

What is claimed is:

1. A nozzle for distributing the flow of a liquid, comprising:
a first module capable of being engaged with a liquid source, said first module defining at least one liquid flow path forming a channel, a first chamber, a portion of a second chamber, and at least one discharge orifice;
a second module defining a portion of said second chamber, and at least one discharge orifice, with said second module forming a top cap;
a connecting means to connect said first and second modules.

2. The nozzle of claim 1, wherein said connecting means is configured to allow said first module and said second module to rotate about an axis defined by said connecting means.
